(19) United States
(12) Patent Application Publication
(10) Pub. No.: US 2008/0120160 A1
(43) Pub. Date: May 22, 2008

(54) Method and system for listing an item

(75) Inventors: Katherine Woo, San Francisco, CA (US); Brian Andrew Phillips, San Francisco, CA (US); Matthew Mengerink, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/601,901

(22) Filed: Nov. 20, 2006

(51) Int. Cl. G06Q 30/00; G06Q 10/00

(52) U.S. Cl. 705/8; 705/28; 705/14; 705/27

(57) ABSTRACT

An inventory number identifier may be associated with an item number of an inventory account within a system inventory. The inventory number identifier may indicate a number of units of the item available for purchase according to the inventory account of a user. The inventory number identifier may be selected for inclusion among one or more selected identifiers for advertisement generation. An advertisement including the selected identifiers for the item may be generated. The advertisement may be made available within a first system for an item in an inventory account of a user of a second system. The inventory number identifier of the advertisement may be updated by accessing the inventory account of the user. The advertisement may then be displayed within the first system.

### FIELD

The present application relates generally to the technical field of data-processing and, in one specific example, to a method and system for listing items.

### BACKGROUND

Products and services may be listed and ultimately sold through various mechanisms. Certain information regarding the sales may be retained and used for data mining and tracking down fraudulent transactions.

### BRIEF DESCRIPTION OF THE DRAWINGS

Some embodiments are illustrated by way of example and not limitation in the figures of the accompanying drawings in which:

FIG. 1 is a network diagram depicting a network system, according to one embodiment, having a client server architecture configured for exchanging data over a network;

FIG. 2 is a block diagram illustrating an example embodiment of multiple network and marketplace applications, which are provided as part of the network-based marketplace;

FIG. 3 is a high-level entity-relationship diagram, in accordance with one example embodiment, illustrating various tables that may be maintained within one or more databases;

FIG. 4 is a block diagram of an attribute table according to an example embodiment;

FIG. 5 is a block diagram of an example database;

FIG. 6 is a block diagram of transactional information according to an example embodiment;

FIG. 7 is a flowchart illustrating a method for managing an inventory account according to an example embodiment;

FIG. 8 is a flowchart illustrating a method for adding an item to an inventory account according to an example embodiment;

FIG. 9 is a flowchart illustrating a method for modifying the advertising parameters according to an example embodiment;

FIG. 10 is a flowchart illustrating a method for listing an item according to an example embodiment;

FIG. 11 is a flowchart illustrating a method for accessing one or more items according to an example embodiment;

FIG. 12 is a flowchart illustrating a method for accessing information for one or more items according to an example embodiment;

FIG. 13 is a flowchart illustrating a method for creating an advertisement for one or more items according to an example embodiment;

FIG. 14 is a flowchart illustrating a method for providing an advertisement according to an example embodiment;

FIG. 15 is a block diagram of an advertisement according to an example embodiment;

FIG. 16 is a block diagram of an advertisement according to an example embodiment;

FIG. 17 is a block diagram of an advertisement according to an example embodiment;

FIG. 18 is a flowchart illustrating a method for providing post-listing for an item according to an example embodiment;

FIG. 19 is a flowchart illustrating a method for evaluating a buyer warning according to an example embodiment;

FIG. 20 is a flowchart illustrating a method for taking a final disposition action according to an example embodiment; and

FIG. 21 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for listing availability of an item (e.g., goods or services) are described. In the following description, for purposes of explanation, numerous specific details are set forth in order to provide a thorough understanding of example embodiments. It will be evident, however, to one skilled in the art that the present invention may be practiced without these specific details

Transactional information for a networked system may be retained in a database. The transaction information may include system inventory with a number of inventory accounts, an images collection, and advertising data. The inventory accounts may enable a seller to manage inventory and list items through the networked system. Advertisements with identifiers may be created for items that are listed for sale within the networked system. A product catalog may be created by use of the networked system and may be utilized to obtain additional information regarding items listed.

A user profile of a buyer may be checked when an offer to purchase an item is made by the buyer. Once the item is purchased, an order criteria may be checked to determine whether an additional number of items should be ordered by the seller.

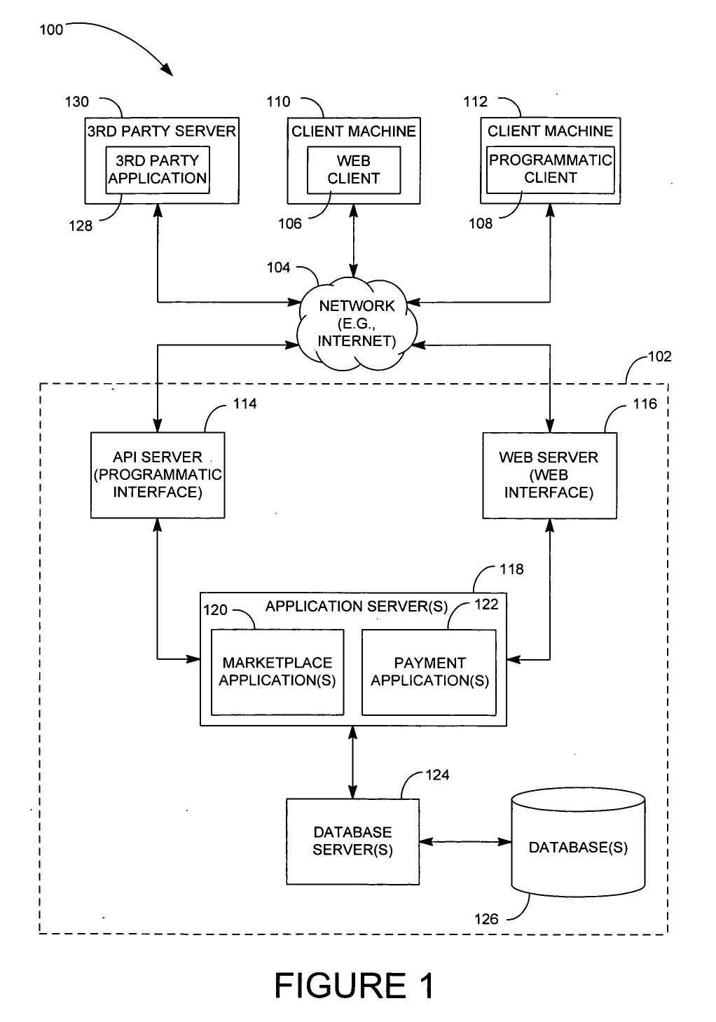

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings (e.g., notices of the availability of items for sale or auction) on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

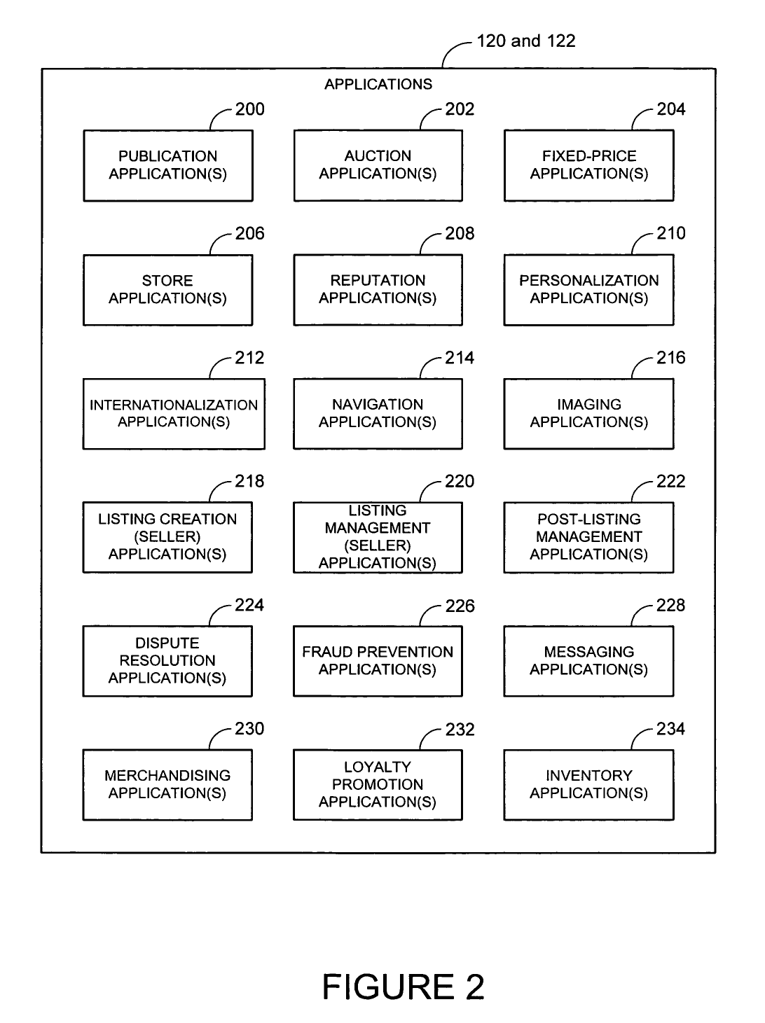

FIG. 2 is a block diagram illustrating multiple applications 120 and 122 that, in one example embodiment, are provided as part of the networked system 102 (see FIG. 1). The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized and/or localized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or system inventory structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one have a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

Inventory applications 234 may assist sellers in managing inventory of items (e.g., goods and/or services), such as items made available within the marketplace applications 120. For example, inventory information regarding the items may be uploaded to and managed by the inventory application 234. In an example embodiment, additional information regarding the items and/or in inventory may be made obtained through scraping, crawling and/or an API.

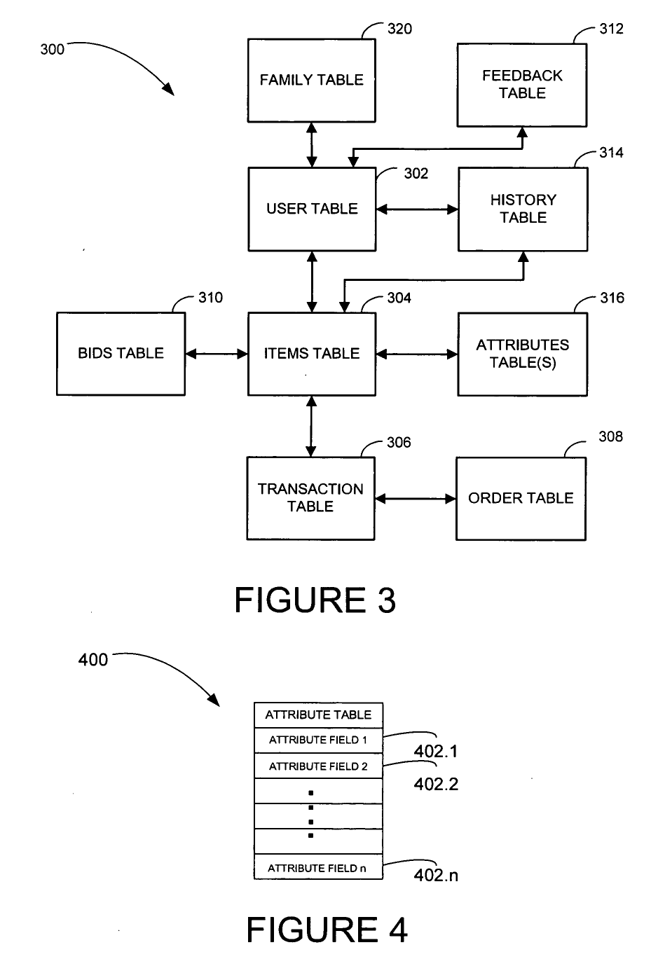

FIG. 3 is a high-level entity-relationship diagram, illustrating various tables 300 that may be maintained within the databases 126, and that are utilized by and support the applications 120 and 122 (see FIG. 1). A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items (e.g., products and/or services) that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order for a good and/or service. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attribute tables 316 record attribute information pertaining to items for which records exist within the items table 304. Considering only a single example of such an attribute, the attribute tables 316 may indicate a currency attribute associated with a particular item, the currency attribute identifying the currency of a price for the relevant item as specified in by a seller.

Referring to FIG. 4, an example embodiment of an attribute table 400 is illustrated. In an example embodiment, the attribute table 316 (see FIG. 3) may include the attribute table 400.

The attribute table 400 may include a number of attribute fields 402.1-402.n. The attribute table 400 may reflect an item in a product category, such that the attribute fields 402.1-402.n may reflect attributes of the item. For example, if the attribute table 400 is for a dress, the attribute fields may retain information regarding the item include designer (e.g., Anne Taylor), color (e.g., black), size (e.g., medium) and condition (e.g., excellent).

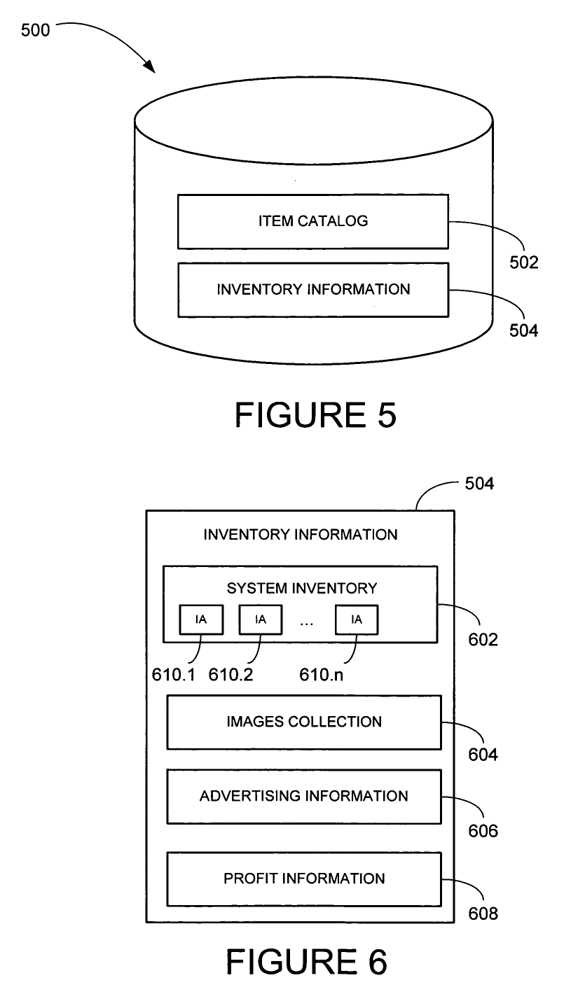

Referring to FIG. 5, an example embodiment of a database 500 is illustrated. In an example embodiment, the databases 126 (see FIG. 1) may include the database 500. The database 500 may include an item catalog 502 and inventory information 504. The item catalog 502 and the inventory information 504 may be together in a single database 500, and/or may each be in one or more databases 500.

The item catalog 502 may include information regarding items (e.g., goods and/or services) that have been bought and/or sold through the application servers 118 (see FIG. 1). For example, the item catalog may include information from the items table 304, the transaction table 306, the order table 308, the bids table 310, the history table 314 and/or the attribute table 316 (see FIG. 3). In an example embodiment, the item catalog 502 may include information regarding item types received from the third party application 128 (see FIG. 1).

In an example embodiment, a structure of the item catalog 502 may include a category, one or more subcategories, and an item type. For example the category may be “antiques”, the subcategory may be “silver”, and the item type may be “Gorham All Sterling Grape Shears”. The inventory application 234 (see FIG. 2) may create and provide further information to the item catalog 502. The category information and item type information, discussed above, may be for example constituted attributes stored in the attribute table 316.

The inventory information 504 may include information regarding the management of items by buyers and/or sellers of the networked system 102. The inventory information 504 may be created by the inventory application 234 (see FIG. 2). An example embodiment of the inventory information 504 is described in greater detail below.

Referring to FIG. 6, an example embodiment of inventory information 504 (see FIG. 5) is illustrated. As shown, the inventory information 504 may include a system inventory 602, an images collection 604, advertising information 606, and profit information 608.

The system inventory 602 may include a number of inventory accounts 610.1-610.n for users. Each of the inventory accounts 610.1-610.n reflects items in an inventory of a user of the networked system 102. For example, the inventory account 610 of a user may indicate that the user has ten particular shirts in a size medium and fifteen particular shirts in a size large.

The images collection 604 may include the images uploaded by the one or more imaging applications 216 (see FIG. 2) for use with listings. The images collection 604 may associate the images with users of the networked system 102 through use of information from the user table 302, the items table 304, the transaction table 306, the order table 308, the bids table 310, the history table 314 and/or the attribute table 316 (see FIG. 3). The images collection 604 may include listing images from a plurality of previous listings.

The advertising information 606 may include a history of advertisements (e.g., promotional information to encourage users to view a listing and purchase an item) and historical sales information relating to the advertisements for items sold through the system inventory 602. For example, the advertising information 606 may be used to determine the effectiveness of the advertisements in selling items of the user.

The profit information 608 may include the profit and/or margin of items sold by users, such that advertisements may be analyzed and/or optimized according to return (e.g., profit) on investment (e.g., cost of the advertisement). The profit information 608 may be calculated separately for each of the inventory accounts 610.1-610.n and/or may be calculated collectively for all of the inventory accounts 610.1-610.n.

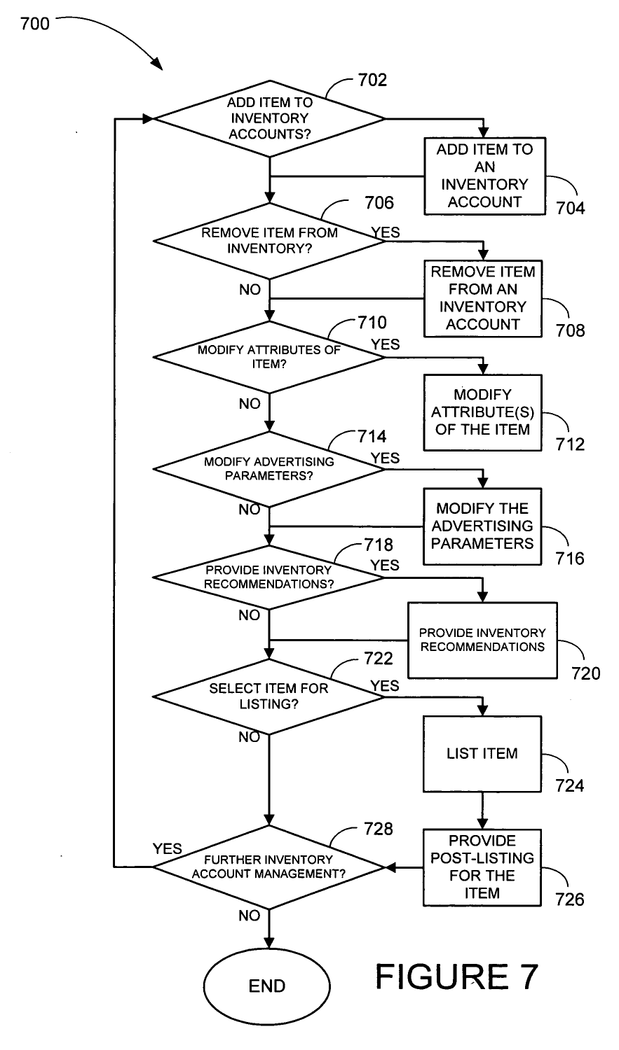

Referring to FIG. 7, a method 700 in accordance with an example embodiment for managing an inventory account is illustrated. In an example embodiment, the inventory applications 234 may perform the operations of the method 700 on the inventory account 610 of the system inventory 602 (see FIGS. 2 and 6).

A determination may be made at decision block 702 whether to add an item to the inventory account 610 of a user. For example, the user of the inventory account 610 at decision block 702 may decide to add an item to the inventory account 610 associated with the user.

If a determination is made to add the item to the inventory account 610, the item may be added to the inventory account 610 of the user at block 704. An example embodiment of adding an item to the inventory account 610 is described in greater detail below. If a determination is made to not add an item to the inventory account 610 at decision block 702 or upon completion of the operations at block 704, the method 700 may proceed to decision block 706.

At decision block 706, a determination may be made whether to remove an item from the inventory account 610 of a user. For example, the user of the inventory account 610 may decide to remove a good and/or service from the inventory account 610. If a determination is made to remove the item from the inventory account 610, the item may be removed from the inventory account 610 of the user at block 708. If a determination is made to not remove the item from the inventory account 610 at decision block 706 or upon completion of the operations at block 708, the method 700 may proceed to decision block 710.

A determination may be made at decision block 710 whether to modify one or more attributes of an item in the inventory account 610 of a user. If a determination is made to modify the attributes of the item, modify one or more of the attributes of the item in the inventory account 610 of the user may be modified at block 712. If a determination is made to not modify the attributes of the item at decision block 710 or upon completion of the operations at block 712, the method 700 may proceed to decision block 714.

At decision block 714, a determination may be made whether to modify the advertising parameters of the user. If a decision is made to modify the advertising parameters of the user, the advertising parameters may be modified at block 716. For example, the advertising parameters may define parameters (e.g., overall advertising budget, items eligible for advertising, advertising budget for items, advertising source selection, and advertising market selection) of when an advertisement may be created for a listing of an item by the inventory application 234 and/or when the inventory application 234 should recommend to a seller to place advertising on an item. An example embodiment of modifying the advertising parameters is described in greater detail below. If a determination is made not to modify the advertising parameters at decision block 714 or upon completion of the operations at block 716, the method 700 may proceed to decision block 718.

A determination may be made at decision block 718 whether to provide inventory recommendations. If inventor recommendations are to be provided, the recommendations for additional inventory to add may be based on information from the user table 302, the items table 304, the transaction table 306, the order table 308, the bids table 310, the history table 314, the attribute table 316 and/or advertising information 606 (see FIGS. 3 and 6) may be provided at block 720. For example, the inventory recommendations may include items to order and/or when to order items based on items listed. In an example embodiment, based on an amount of advertising purchased, a prediction of the number of items needed for the inventory account 610 and how many items will be sold from the inventory account 610. If no inventory recommendations are to be received at decision block 718 or upon completion of the operations at block 720, the method 700 may proceed to decision block 722.

A determination may be made at decision block 722 whether an item has been selected for listing. If the item has been selected for listing, the item may be listed at block 724 and post-listing for the item may be provided at block 726. Example embodiments of listing the item and providing post-listing for the item are described in greater detail below. If the item has not been selected for listing at decision block 722 or upon completion of the operations at block 726, the method 700 may proceed to decision block 728.

At decision block 728, a determination may be made as whether to provide further management of the inventory account 610. If further inventory account management is to be provided, the method 700 may return to decision block 702. If further inventory account management is not to be provided, the method 700 may terminate.

In an example embodiment, the inventory account 610 of a user may be modified at the direction of the user during the operations of the method 700. For example, the user account may be modified by changing a user name and/or password, altering contact information, adding banking information, and the like.

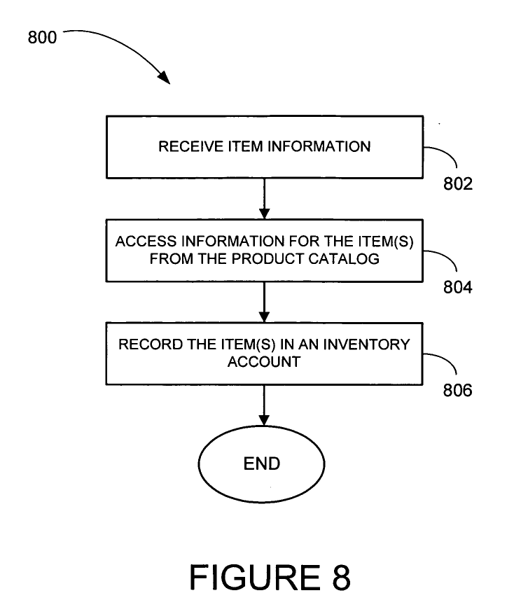

Referring to FIG. 8, a method 800 according to an example embodiment for adding an item to the inventory account 610 is illustrated. In an example embodiment, the method 800 may be performed at block 704 (see FIG. 7). In an example embodiment, the method 800 may be performed by the inventory applications 234 (see FIG. 2).

Item information may be received for an item at block 802. For example item information provided by a user may include a category of an item, a subcategory of an item, an item type, and/or attributes of the item such as make, manufacturer, size, color, condition, year, and the like.

Additional information for the item may be accessed from the item catalog 502 (see FIG. 5) at block 804. For example, the additional information may be retrieved from the item catalog 502 to supplement the item information provided at block 802. In an example embodiment, additional information for the item may be obtained by scraping and/or crawling third party sources. An example embodiment of accessing information for the item is described in greater detail below.

At block 806, the item may be recorded in the inventory account 610 of the user. For example, the item upon recordation may be available within the inventory account 610 of the user, such that it may be used by the inventory applications 234. Upon completion of the operations at block 806, the method 800 may terminate.

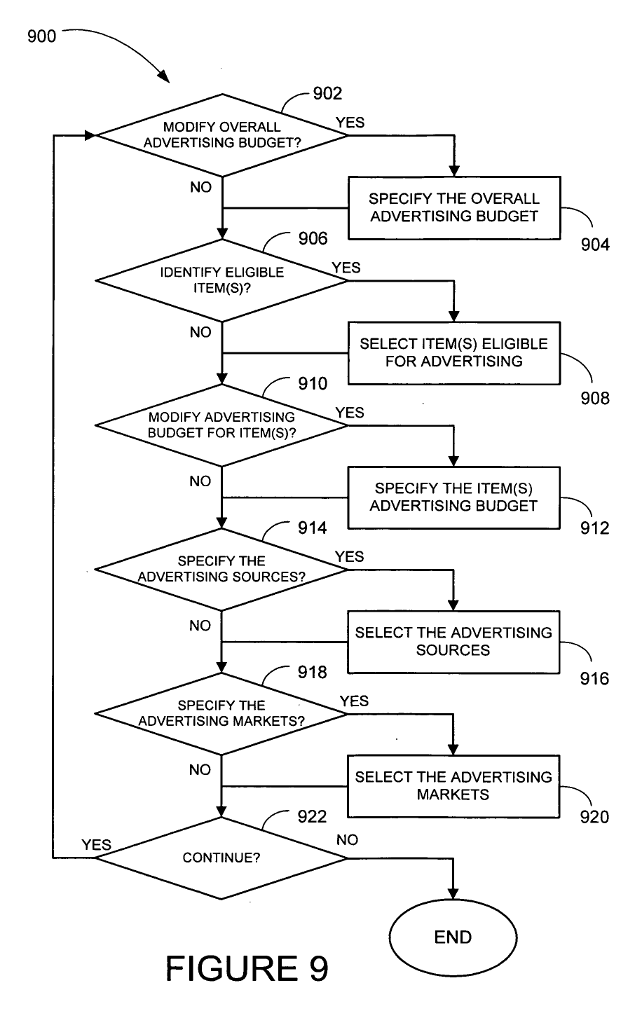

Referring to FIG. 9, a method 900 in accordance with an example embodiment for modifying the advertising parameters is illustrated. In an example embodiment, the method 900 may be performed at block 716 (see FIG. 7).

A determination may be made at decision block 902 whether to modify an overall advertising budget. For example, the overall advertising budget may be a budget specified by a user and/or a budget generated (e.g., as a percentage of revenues) by the inventory application 234 (see FIG. 2) to sell the items in the inventory account 610 (see FIG. 6). If a determination is made to modify the overall advertising budget, the overall advertising budget may be specified at block 904. If the overall advertising budget is not to be modified at decision block 902 or upon completion of the operations at block 904, the method 900 may proceed to decision block 906.

At decision block 906, a determination may be made whether to identify one or more items in the inventory account 610 as being eligible for advertising. If the eligible items are to be identified, one or more items may be selected within the inventory account 610 as being eligible for advertising. For example, specifying the items that are eligible for advertising may enable the inventory application 234 to determine the items for which it may select for advertising. If the eligible items are not be identified at decision block 906 or upon completion of the operations at block 908, the method 900 may proceed to decision block 910.

A determination may be made at decision block 910 whether to modify an advertising budget for any of the eligible items in the inventory account 610. If the advertising budget is to modified for any of the eligible items, an item advertising budget may be modified for one or more items at block 912. For example, the item advertising budget may a hard dollar amount (e.g., fifty dollars a week or a thousand dollars a year) or may be a dynamic dollar amount (e.g., based on a percentage of revenue). If the advertising budget is to modified at decision block 910 or upon completion of the operations at block 912, the method 900 may proceed to decision block 914.

At decision block 914, a determination may be made whether to specify one or more advertising sources where the items of the inventory account 610 may be advertised. If the advertising sources are to be specified, the method 900 may select the advertising sources where the items of the inventory account 610 may be advertised at block 916. For example, the sources may include sponsored advertising, classified web postings, keyword advertising, banner advertising, text message advertising, short message service (SMS) advertising, a real simple syndication (RSS) feed advertising, instant message advertising and/or print advertising. Other advertising sources may also be used. If the sources are not be specified at decision block 914 or upon completion of the operations at block 916, the method 900 may proceed to decision block 918.

A determination may be made at decision block 918 whether to specify the advertising markets in which the items in the inventory account 610 may be advertised. For example, the advertising markets may be regional, geographic, item-type specific (e.g., an electronics website), and the like. If the advertising markets are to be specified, the advertising markets may be specified at block 920. If the advertising markets are not to be specified at decision block 918 or upon completion of the operations at block 920, the method 900 may proceed to decision block 922.

At decision block 922, a determination may be made whether to continue the operations of the method 900. If the operations are to continue, the method 900 may return to decision block 922. If the operations are not to continue at decision block 922, the method 900 may terminate.

In an example embodiment, the overall advertising budget, the items eligible for advertising (e.g., item eligibility for advertising), the items advertising budget (e.g., an advertising budget for the item), the advertising sources selected, and/or the advertising markets may be used by the inventory application 234 as advertising criteria to determine whether an advertisement should be created for a listing.

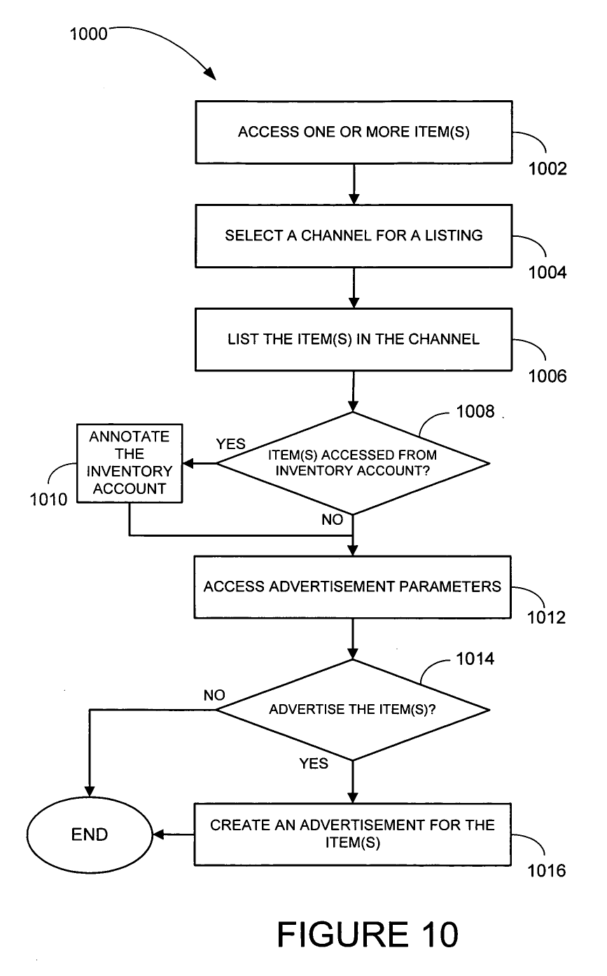

Referring to FIG. 10, a method 1000 in accordance with an example embodiment for listing an item is illustrated. In an example embodiment, the method 1000 may be performed at block 724 (see FIG. 7). In an example embodiment, the listing creation applications 218, the listing management applications 220, and/or the inventory applications 234 may perform the operations of the method 1000 (see FIG. 2).

One or more items may be accessed at block 1002. For example, an item may be accessed from the inventory account 610 (see FIG. 6) of a user. The item selected for listing may be chosen by a seller and/or based on data stored in the advertising information 606. An example embodiment of accessing an item is described in greater detail below.

A channel may be selected for a listing of the item at block 1004. For example, the channel may include a listing for an auction, a fixed-price sale, and/or a store. In an example embodiment, the listing may include an item number (e.g., a number of the items) and a price for the item number (e.g., how much each item costs and/or a total price for the items). The item may be listed for sale (e.g., at a fixed price or through auction) in the channel at block 1006.

At decision block 1008, a determination may be made as to whether an item is selected from the inventory account 610 of a user. If the item is selected from the inventory account 610 of the user, the inventory account 610 may be annotated at block 1010. For example, annotating the inventory account 610 may indicate where, when and for how long an item is being offered for sale and/or to prevent multiple sales of a same item. If the item is selected from the inventory account 610 of the user at decision block 1008 or after block 1010, the method 1000 may proceed to block 1012.

The method 1000 may optionally access the advertisement parameters at block 1012. For example, the advertisement parameters may include user specified advertisement parameters from the operations at block 716 (see FIG. 7) and/or system specified advertisement parameters. The system specified parameters may include overall advertising budget as a percentage of revenue, item advertising budget as a percentage of revenue, advertising sources based on previous effectiveness, market selection based on previous effectiveness, and the like.

A determination may be made at decision block 1014 whether to advertise the item. For example, the determination may be based on the accessed advertisement parameters at block 1012 and/or by an election of a user. If the item is to be advertised, an advertisement may be created for the item at block 1016 by generating the advertisement with the inventory application 234 (see FIG. 2). In an example embodiment, selection of items from the inventory account 610 of a user may be based on the advertising information 606 (see FIG. 6). An example embodiment of a method for creating an advertisement for the item is described in greater detail below. If the item is not to be advertised at decision block 1014 or upon completion of the operations at block 1016, the method 1000 may terminate.

In an example embodiment, the determination of whether to advertise the item and/or where to advertise the item may be based on an advertising budget specified by the seller, an advertisement spending limit (e.g., a daily spending limit or a monthly spending limit), a percentage of the revenue of the item, a percentage of the profit of the item, and the like.

It should be appreciated that block 1006, decision block 1008 and decision block 1014 may occur in any order.

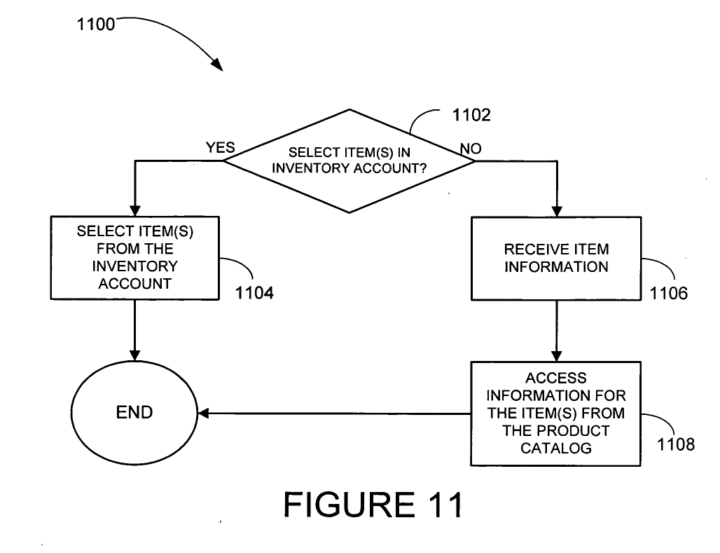

Referring to FIG. 11, a method 1100 in accordance with an example embodiment for accessing one or more items is illustrated. In an example embodiment, the method 1100 may be performed at block 1002 (see FIG. 9).

At decision block 1102, a determination may be made as to whether to select one or more items are in the inventory account 610 (see FIG. 6). If items in the inventory account 610 are to be selected, the items may be selected from the inventory account 610 at block 1104. In an example embodiment, selecting items from the inventory account 610 may include receiving an item type and attributes associated with the items within the inventory account 610.

If the items in the inventory account 610 are not to be selected at decision block 1102, item information may be received from a user at block 1106 and additional information for the items may be accessed from the item catalog 502 (see FIG. 5) at block 1108. An example embodiment of accessing information for the items is described in greater detail below.

Upon completion of the operations at block 1104 or block 1108, the method 1100 may terminate.

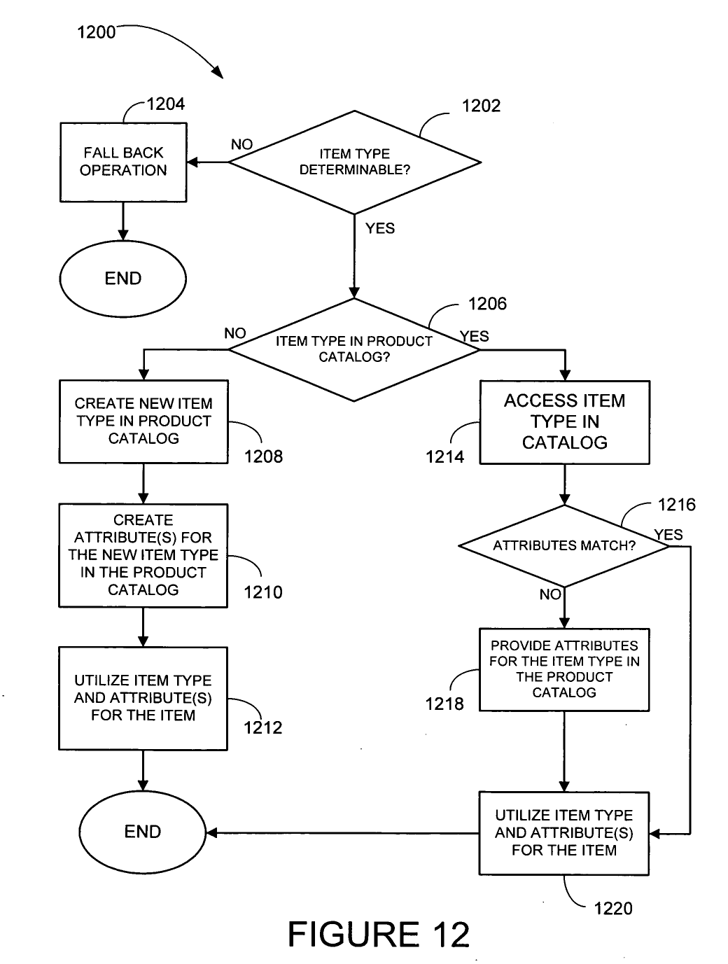

Referring to FIG. 12, a method 1200 in accordance with an example embodiment for accessing information for one or more items from the item catalog 502 (see FIG. 5) is illustrated. In an example embodiment, the method 1200 may be performed at block 804 and/or block 1108 (see FIGS. 8 and 11).

At decision block 1202, a determination may be made as to whether an item type of the one or more items are determinable. For example, the item type may be a type of item (e.g., a black dress) without attributes (e.g., color, size, and condition) of a particular item. If the item type is not determinable, a fall back operation may be performed at block 1204. In an example embodiment, the fall back operation may include prompting the user for input on the item type and/or not providing further information regarding the attributes of the item type. If the item type is determinable at decision block 1202, the method 1200 may proceed to decision block 1206.

A determination may be made at decision block 1206 as to whether the item type is in the item catalog 502 (see FIG. 5). If the item type is not in the item catalog 502, a new item type may be created in the item catalog 502 at block 1208. One or more attributes for the new item type may be created in the item catalog 502 at block 1210. The item type and the attributes may be used for the one or more items at block 1212.

If at decision block 1206 the item type is in the item catalog 502, the item type may be accessed in the item catalog 502 at block 1214. At decision block 1216, a determination may be made as to whether the attributes of the item type match. If the attributes for the item types do not match, the attributes for the item type in the item catalog 502 may be provided at block 1218. In an example embodiment, the attributes for the item type may be automatically provided to the user and/or selected by the user.

If the item types do not match at decision block 1216 or upon completion of the operations at block 1218, the item type and the attributes may be utilized for the one or more items at block 1220. Upon completion of the operations at block 1212 or block 1220, the method 1200 may terminate.

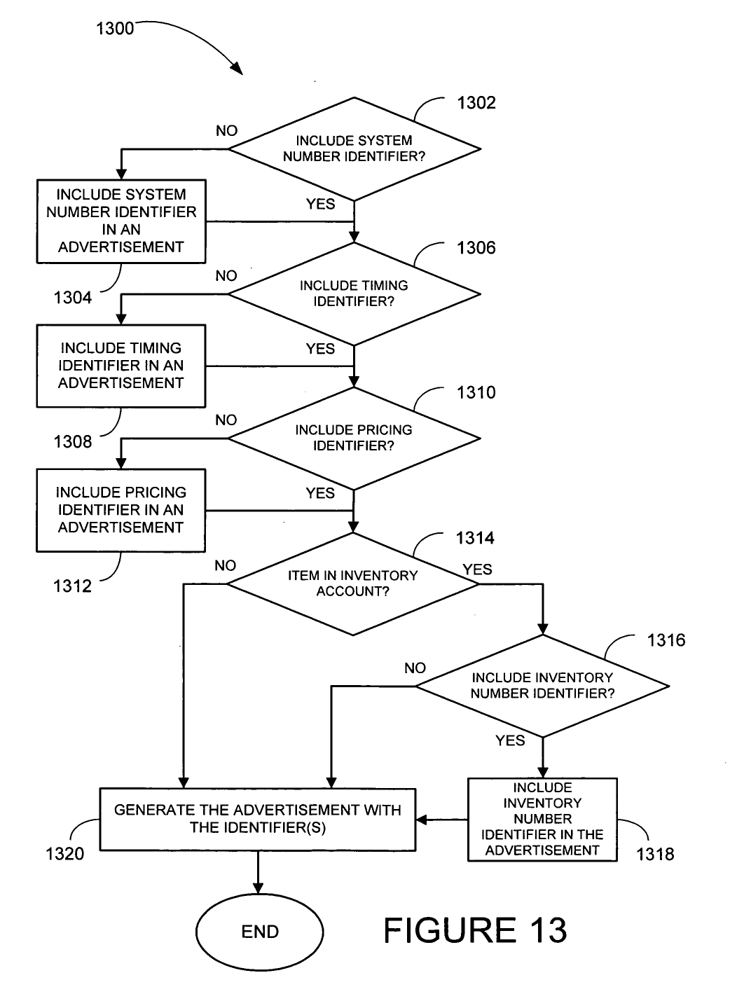

Referring to FIG. 13, a method 1300 in accordance with an example embodiment for creating an advertisement (e.g., promotional information to encourage user to view a listing of one or more items for a fixed-price sale and/or auction and to purchase and/or bid for the items) for one or more items is illustrated. In an example embodiment, the method 1300 may be performed at block 1016 (see FIG. 10).

A determination may be made at decision block 1302 whether to include a system number identifier in an advertisement. For example, the system number identifier may dynamically indicate a number of items available in the system inventory 602 for all users (e.g., a number of items available through the networked system 102). In an example embodiment, the system number identifier may include an association (e.g., a link) to the system inventory 602 (see FIG. 6), such that the system number identifier may include real-time time information regarding the system inventory 602.

If a determination is made to include the system number identifier in the advertisement, the system number identifier may be included in the advertisement at block 1304. If a determination is made not to include the system number identifier in the advertisement at decision block 1302 or upon completion of the operations at block 1304, the method 1300 may proceed to decision block 1306.

At decision block 1306, a determination may be made whether to include a timing identifier in the advertisement. In an example embodiment, the timing identifier may include association (e.g., a link) with a timing element of the listing. For example, the timing element may dynamically indicate when the listing starts and/or ends.

If a determination is made to include the timing identifier in the advertisement, the timing identifier may be included in the advertisement at block 1308. If a determination is made not to include the timing identifier in the advertisement at decision block 1306 or upon completion of the operations at block 1308, the method 1300 may proceed to decision block 1310.

A determination may be made at decision block 1310 whether to include a pricing identifier in the advertisement. The pricing identifier may include an association (e.g., a link) with a price of the one or more items in the listing. For example, the association with the listing may enable the pricing identifier to dynamically reflect changes in the pricing of the item.

In an example embodiment, the pricing identifier may be a timed pricing identifier, where the price of the one or more items in the listing may be decreased (or increased) after a fixed time period (e.g., after 3 days) such as by being associated with the timing identifier, or a variable time period (e.g., after only 10 items remain) such as by being associated with the system number identifier and/or the inventory number identifier (e.g., indicating a number of units of the item available for purchase according to the inventory account 610 of a user).

If a determination is made to include the pricing identifier in the advertisement, the pricing identifier may be included in the advertisement at block 1312. If a determination is made not to include the pricing identifier in the advertisement at decision block 1310 or upon completion of the operations at block 1312, the method 1300 may proceed to decision block 1314.

At decision block 1314, a determination may be made as to whether the item to be advertised is included in the inventory account 610 of the user. If a determination is made that the item to be advertised is not included in the inventory account 610, the method 1300 may proceed to block 1320.

If a determination is made that the item to be advertised is included in the inventory account 610, a determination may be made at decision block 1316 whether to include an inventory number identifier in the advertisement. For example, the inventory number identifier may be associated with an item number (e.g., a number of items) of the one or more items in the inventory account 610, such that the inventory number identifier may dynamically reflect the item number of the one or more items available in the inventory account 610.

If a determination is made not to include the inventory number identifier in the advertisement, the method 1300 may proceed to block 1320. If a determination is made to include the inventory number identifier in the advertisement at decision block 1316, the inventory number identifier may be included in the advertisement at block 1318.

The advertisement may be generated for the item with the one or more identifiers at block 1320 and/or the advertisement information may be provided to another to generate the advertisement for the item with the one or more identifiers. In an example embodiment, the one or more identifiers selected from among available identifiers may be associated with the item in the inventory account 610 of the user, such that changes to the inventory account 610 may affect the advertisement. For example, a change in a number of items in the inventory account 610 of the user may be reflected in the advertisement.

Upon completion of the operations at block 1320, the method 1300 may terminate.

It may be appreciated that the advertisement generated during the operations at block 1320 may pull dynamic information (e.g., real-time inventory information, pricing information and auction duration information) from the marketplace applications 120 (see FIG. 1), and including the dynamic information in an advertisement that may be displayed “off site” of the marketplace applications 120.

In an example embodiment, the use of the identifiers with the advertisement may encourage users to seek additional information on the advertised items, such as by clicking on a link associated with the advertisement to view the listing of the items. For example, the use of the identifiers may generate additional click-through traffic.

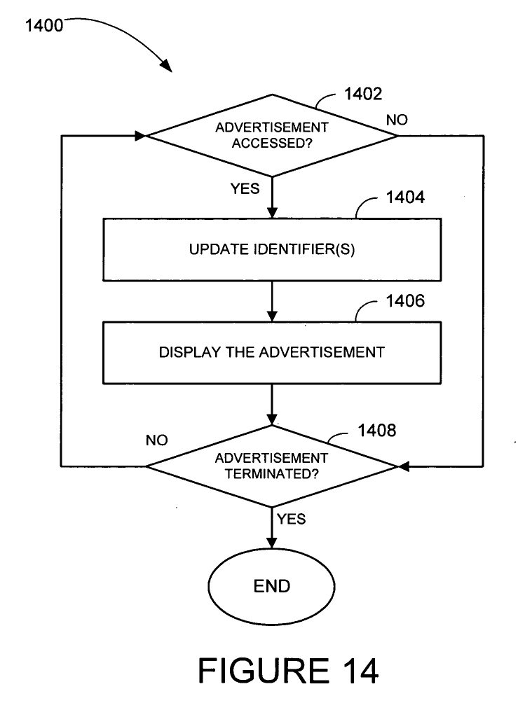

Referring to FIG. 14, a method 1400 in accordance with an example embodiment for providing an advertisement is illustrated. In an example embodiment, the advertisement may be the advertisement generated during the operations at block 1320 (see FIG. 13).

In an example embodiment, the advertisement may a sponsored match result, a keyword advertisement (e.g., such as ADWORDS by Google Inc. of Mountain View, Calif.), a banner advertisement a text message advertisement, a short message service (SMS) advertisement, a real simple syndication (RSS) feed advertisement, an instant message advertisement, and a classified website posting. Other advertisements may also be used.

At decision block 1402, a determination may be made as to whether the advertisement has been accessed. For example, the advertisement may be accessed when it is presented to a user in a first system, such as a person viewing a web page with the advertisement. If the advertisement has not been accessed, the method 1400 may proceed to decision block 1408. In an example embodiment, the advertisement made available from a first system (e.g., a third party webpage in which the advertisement is made available) for an item in an inventory account of a user of a second system (e.g., the networked system 102), where the advertisement includes an inventory number identifier associated with an item number of the item in the inventory account 610 (see FIG. 6) of the user.

If the advertisement has been accessed at decision block 1402, the identifiers may be updated at block 1404 (e.g., the number identifier of the advertisement may be updated by accessing the inventory account 610) and the advertisement may be displayed (e.g., within the first system) at block 1406. For example, the identifiers may be updated by obtaining dynamic information through associations (e.g., links), such as an association with the system inventory 602 (see FIG. 6), the inventory account 610 and/or the listing of the item. By displaying the advertisement, the advertisement may be made available to potential purchasers of the items (e.g., buyers) that see dynamic information available within the advertisement.

At decision block 1408, a determination may be made as to whether the advertisement has been terminated. For example, the advertisement may terminate if there are no more items left in the inventory account 610 of a user or the time allotted to the listing has expired. If the advertisement has not been terminated, the method 1400 may return to decision block 1402. If the advertisement has been terminated at decision block 1408, the method 1400 may terminate.

In an example embodiment, the method 1400 may occur within the networked system 102 (see FIG. 1) and/or outside of the networked system 102.

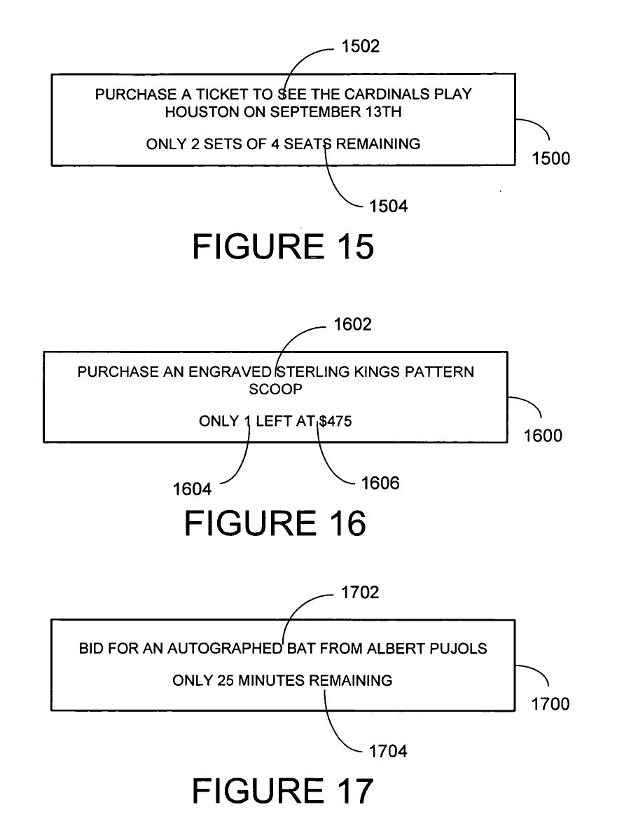

Referring to FIG. 15, an advertisement 1500 according to example embodiment is illustrated. In an example embodiment, the advertisement 1500 may be created by the operations performed at block 1016 (see FIG. 10).

The advertisement 1500 may include an item content 1502, which may describe an item being listed. As illustrated, the item content 1502 states “PURCHASE A TICKET TO SEE THE CARDINALS PLAY HOUSTON ON SEPTEMBER 13TH”. In an example embodiment, the item content 1502 may include an incentive, such as a rebate offer, a protection package, and the like.

The advertisement 1500 may include a system number content 1504, such that the system number content 1504 may identify a number of the items available in the system. As illustrated, the system number content 1504 states “ONLY 2 SETS OF 4 SEATS REMAINING”.

Referring to FIG. 16, an advertisement 1600 according to example embodiment is illustrated. In an example embodiment, the advertisement 1600 may be created by the operations performed at block 1016 (see FIG. 10). The advertisement 1600 may include an item content 1602, which may describe an item being listed. As illustrated the item content 1602 states “PURCHASE AN ENGRAVED STERLING KINGS PATTERN SCOOP”.

The advertisement 1600 may include an inventory number content 1604 and a pricing content 1606. The inventory number content 1604 may identify a number of items available in the inventory account 610 (see FIG. 6) of a user. The pricing content 1606 may identify the price at which the item is currently being listed. As illustrated, the inventory number content 1604 states “ONLY 1 LEFT” and the pricing content 1606 states “AT $475”.

Referring to FIG. 17, an advertisement 1700 according to example embodiment is illustrated. In an example embodiment, the advertisement 1700 may be created by the operations performed at block 1016 (see FIG. 10). The advertisement 1700 may include an item content 1702, which may describe an item being listed. As illustrated the item content 1702 states “BID FOR AN AUTOGRAPHED BAT FROM ALBERT PUJOLS”.

The advertisement may include a timing content 1704 that may indicate an amount of time remaining in a listing and/or a start time of a listing. As illustrated the timing content 1704 states “ONLY 25 MINUTES REMAINING”.

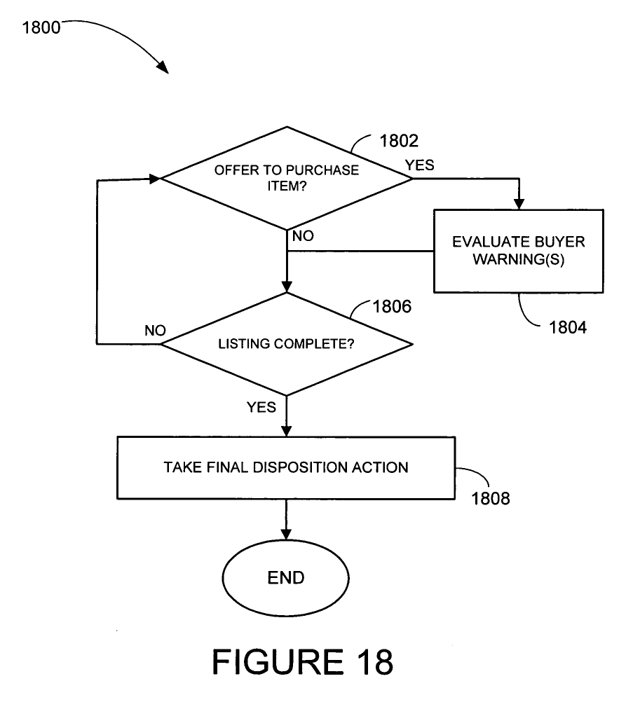

Referring to FIG. 18, a method 1800 in accordance with an example embodiment for providing post-listing for an item is illustrated. In an example embodiment, the method 1800 may be performed at block 726 (see FIG. 7). In an example embodiment, the post-listing applications 222 and/or the inventory applications 234 may perform the operations of the method 1800 (see FIG. 2).

At decision block 1802, a determination may be made as to whether an offer to purchase (or an actual purchase of) the item has been received. If the offer to purchase the item has been received, one or more buyer warnings may be evaluated at block 1804. For example, the buyer warnings may include warnings that the a purported user making an offer to purchase the item may be actually be the purported user. An example embodiment of evaluating buyer warnings is described in greater detail below. If the offer to purchase the item has not been received at decision block 1802 or upon completion of the operations at block 1804, the method 1800 may proceed to decision block 1806.

At decision block 1806, a determination may be made as to whether a listing of the item is complete. If the listing is not complete, the method 1800 may return to decision block 1802. If the listing is complete at decision block 1806, a final disposition action may be taken at block 1808. An example embodiment of taking the final disposition action is described in greater detail below. Upon completion of the operations at block 1808, the method 1800 may terminate.

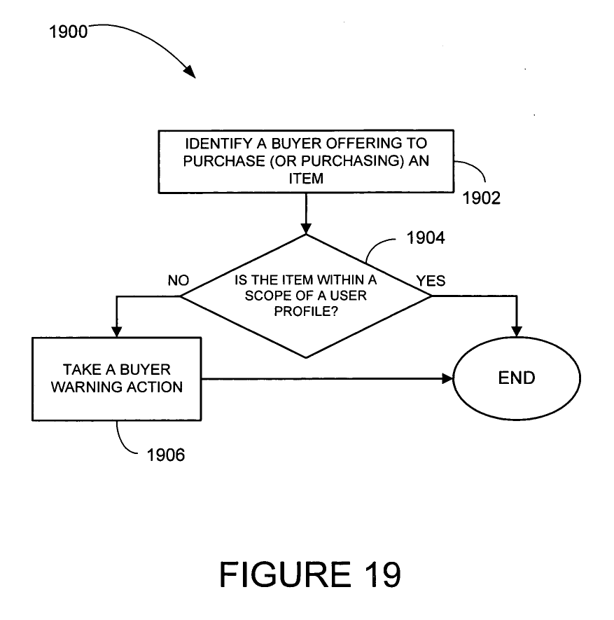

Referring to FIG. 19, a method 1900 in accordance with an example embodiment for evaluating a buyer warning is illustrated. In an example embodiment, the method 1900 may be performed at block 1804 (see FIG. 18).

The method 1900 may identify a buyer offering to purchase and/or purchasing an item from a listing at block 1902. For example, the item may be made available through the networked system 102, such as by listing of the item in the channel during the operation at block 1006 (see FIGS. 1 and 10).

At decision block 1904, a determination may be made as to whether the item is within a scope of a user profile. In an example embodiment, the item may be within the scope of the user profile when the buyer has previously bought or offered to buy a similar item or an item within a same category.

In an example embodiment, the user profile may be created by tracking browsing and/or purchasing habits of a user within the networked system 102.

If the item is not within the scope of the user profile, a buyer warning action may be taken at block 1906. For example, the buyer warning action may include sending a notification to the buyer to confirm the offer and/or purchase. For example, if a user only purchases only SONY products and a purchase is made with the user account of a SAMSUNG product, the method 1900 may take a buyer warning action.

If the item is not within the scope of the user profile at decision block 1904 or upon completion of the operations at block 1906, the method 1900 may terminate. In an example embodiment, taking a buyer warning action may be used to control and/or detect fraud.

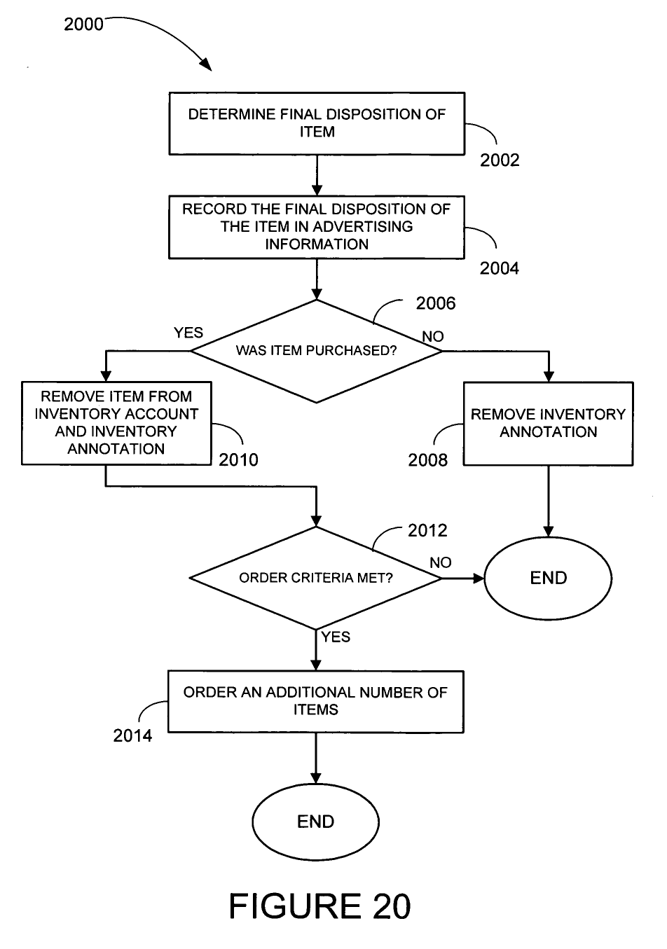

Referring to FIG. 20, a method 2000 in accordance with an example embodiment for taking a final disposition action is illustrated. In an example embodiment, the method 2000 may be performed at block 1808 (see FIG. 18).

A final disposition of an item of a listing may be determined at block 2002. For example, the final disposition may include sold, not sold, and/or minimum not met. In an example embodiment, the final disposition of item may be sold when a user is fulfilling a sale of the item.

In an example embodiment, the item may be listed from an inventory account 610 (see FIG. 6) of a user of a first system (e.g., the networked system 102), the advertisement may be provided for the item in a second system (e.g., a third party web page), and the final disposition of the item may be recorded in advertising information stored within the first system.

The final disposition of the item may be recorded in the advertising information 606 (see FIG. 6) at block 2004. In an example embodiment, the listings for items that have been sold from inventory not through the networked system 102 may be updated.

At decision block 2006, a determination may be made as to whether the item was purchased. If the item was not purchased, an inventory annotation may be removed at block 2008. If the item was determined to have been purchased at decision block 2006, the method 2000 may remove both the item from the inventory account 610 and the inventory annotation at block 2010 and proceed to decision block 2014.

In an example embodiment, the profit information 608 (see FIG. 6) may be updated for the inventory account 610 at block 2010.

At decision block 2014, a determination may be made as to whether an order criteria is met. For example, the order criteria may indicate when additional items are needed to meet a threshold and/or additional items are desired by a user for the inventory account 610 of a user. In an example embodiment, the order criteria may be met may be based on transaction records of the transaction table 306 (see FIG. 3)

If the order criteria is met, an additional number of items may be ordered at block 2016. For example, an additional number of the item may be selectively ordered for the inventory account when a number of item when an ordering criteria is met. If the order criteria is not met at decision block 2014 or upon completion of the operations block 2016, the method 2000 may terminate.

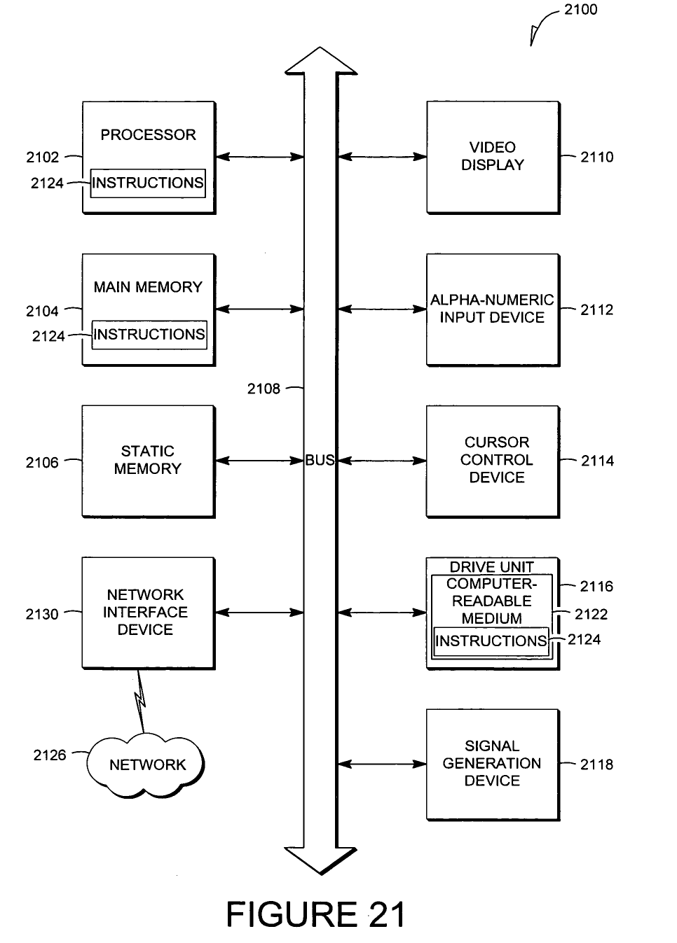

FIG. 21 shows a diagrammatic representation of machine in the example form of a computer system 2100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU) a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a cursor control device 2114 (e.g., a mouse), a disk drive unit 2116, a signal generation device 2118 (e.g., a speaker) and a network interface device 2130.

The disk drive unit 2116 includes a machine-readable medium 2122 on which is stored one or more sets of instructions (e.g., software 2124) embodying any one or more of the methodologies or functions described herein. The software 2124 may also reside, completely or at least partially, within the main memory 2104 and/or within the processor 2102 during execution thereof by the computer system 2100, the main memory 2104 and the processor 2102 also constituting machine-readable media.

The software 2124 may further be transmitted or received over a network 2126 via the network interface device 2130.

While the machine-readable medium 2122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to list items have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
associating an inventory number identifier with an item number of an inventory account within a system inventory, the inventory number identifier indicating a number of units of the item available for purchase according to the inventory account of a user;
selecting the inventory number identifier for inclusion among one or more selected identifiers for advertisement generation; and
generating an advertisement including the selected identifiers for the item.

2. The method of claim 1, further comprising:
associating a system number identifier with the system inventory, the system inventory indicating a number of units of the item available for purchase from all users of a system; and
selecting the system number identifier for inclusion among the selected identifiers for advertisement generation.

3. The method of claim 1, further comprising:
selecting a channel for a listing of the item, the listing including the item number and a price for the item number of the item; and
listing the item for sale in the selected channel.

4. The method of claim 3, further comprising:
associating a pricing identifier with the price of the item, the pricing identifier indicating the price for the item number of the item; and
selecting the pricing identifier for inclusion among the selected identifiers for advertisement generation.

5. The method of claim 3, further comprising:
selecting at least one selected from a group of channels including a listing for an auction, a fixed-price sale, and a store as the channel.

6. The method of claim 1, further comprising:
associating a timing identifier with a timing element of the listing, the timing identifier indicating an amount of time for the listing as identified by the timing element; and
selecting the timing identifier for inclusion among the selected identifiers for advertisement generation.

7. The method of claim 1, wherein accessing an item from an inventory account includes selecting the item from the inventory account.

8. The method of claim 7, further comprising:
receiving an item type and attributes associated with the item from the inventory account.

9. The method of claim 1, wherein accessing an item from an inventory account is performed by:
receiving item information for an item; and
accessing additional information from an item catalog for the item.

10. The method of claim 9, further comprising selecting at least one selected from a group including an item type of the item and one or more attributes of the item as the additional information.

11. The method of claim 1, further comprising:
selecting the item within the system inventory associated with the user of the system inventory as the inventory account.

12. The method of claim 1, further comprising:
selecting at least one from a group of criteria including an overall advertising budget, item eligibility for advertising, an advertising budget for the item, advertising sources selected, and advertising markets selected as the advertising criteria.

13. The method of claim 1, further comprising:
accessing the advertisement made available within a first system for the item;
updating an inventory number identifier of the advertisement by accessing the inventory account of the user, the inventory number identifier indicating a number of units of the item available for sale according to the inventory account of the user; and displaying the advertisement within the first system;
recording a final disposition of the item in advertising information stored within the second system; and
selectively ordering an additional number of the item for the inventory account when an ordering criteria is met.

14. A method comprising:
accessing an advertisement made available within a first system for an item in an inventory account of a user of a second system;
updating an inventory number identifier of the advertisement by accessing the inventory account of the user, the inventory number identifier indicating a number of units of the item available for sale according to the inventory account of the user; and
displaying the advertisement within the first system.

15. The method of claim 14, further comprising:
updating a pricing identifier of the advertisement by accessing a price of the item in a listing of the item within the second system, the pricing identifier indicating the price for the item.

16. The method of claim 14, further comprising:
updating a timing identifier of the advertisement by accessing a timing element of a listing of the item within the second system, the timing identifier indicating an amount of time for the listing as identified by the timing element.

17. The method of claim 14, further comprising:
selecting at least one selected from a group of advertisements including a sponsored match result, a keyword advertisement, a banner advertisement, a text message advertisement, a short message service (SMS) advertisement, a real simple syndication (RSS) feed advertisement, an instant message advertisement, and a classified website posting as the advertisement.

18. A method comprising:
listing an item within a first system from an inventory account of a user of the first system;
providing an advertisement for the item in a second system;
recording a final disposition of the item in advertising information stored within the first system; and
selectively ordering an additional number of the item for the inventory account when an ordering criteria is met.

19. The method of claim 18 further comprising:
fulfilling a sale of the item; and
removing the item from the inventory account.

20. The method of claim 18 further comprising:
selecting at least one selected from a group of criteria including additional items needed to meet a threshold and additional items desired by a user of the inventory account as the ordering criteria.

21. An advertisement comprising:
item content to describe a listing of an item available from an inventory account of a system inventory; and
an inventory number content associated with the inventory account to describe an item number of the item available within the inventory account.

22. The advertisement of claim 21 further comprising:
a pricing content to identify a price at which the item is currently listed.

23. The advertisement of claim 21 further comprising:
a timing content to indicate at least one selected from a group including an amount of time remaining in the listing and a start time of the listing.

24. The advertisement of claim 21 further comprising:
a system number content to identify the item number of the item available in the system inventory.

25. A machine-readable medium comprising instructions, which when executed by a machine, cause the machine to:
associate an inventory number identifier with an item number of an inventory account within a system inventory, the inventory number identifier indicating a number of units of the item available for purchase according to the inventory account of a user;
select the inventory number identifier for inclusion among one or more selected identifiers for advertisement generation; and
generate an advertisement including the selected identifiers for the item.

26. The machine-readable medium of claim 25, further comprising instructions, which when executed by a machine, cause the machine to:
select a channel for a listing of the item, the listing including the item number and a price for the item number of the item; and
list the item for sale in the selected channel.

27. The machine-readable medium of claim 25, further comprising instructions, which when executed by a machine, cause the machine to:
associate a timing identifier with a timing element of the listing, the timing identifier indicating an amount of time for the listing as identified by the timing element; and
select the timing identifier for inclusion among the selected identifiers for advertisement generation.

28. An apparatus comprising:
means for associating an inventory number identifier with an item number of an inventory account within a system inventory, the inventory number identifier indicating a number of units of the item available for purchase according to the inventory account of a user;
means for selecting the inventory number identifier for inclusion among one or more selected identifiers for advertisement generation; and
means for generating an advertisement including the selected identifiers for the item.

29. The apparatus of claim 28, further comprising:
means for associating a system number identifier with the system inventory, the system inventory indicating a number of units of the item available for purchase from all users of a system; and
means for selecting the system number identifier for inclusion among the selected identifiers for advertisement generation.

30. The apparatus of claim 28, further comprising:
means for selecting a channel for a listing of the item, the listing including the item number and a price for the item number of the item; and
means for listing the item for sale in the selected channel.
